(19) United States
(12) Patent Application Publication
(10) Pub. No.: US 2004/0139082 A1
(43) Pub. Date: Jul. 15, 2004

(54) Method for minimizing a set of UDDI change records

(76) Inventors: Robert C. Knauerhase, Portland, OR (US); Scott H. Robinson, Portland, OR (US); Joel D. Munter, Chandler, AZ (US)

Correspondence Address: James H. Salter, Blakely, Sokoloff, Taylor & Zafman LLP, Seventh Floor, 12400 Wilshire Boulevard, Los Angeles, CA, 90025-1030, US

(21) Appl. No.: 10/335,369

(22) Filed: Dec. 30, 2002

(51) Int. Cl. G06F 7/00

(52) U.S. Cl. 707/100

(57) ABSTRACT

A method for optimizing the processing of UDDI change records is disclosed. In one embodiment the method comprises receiving a list of change records and minimizing the list of change records that need to be processed.

### FIELD OF THE INVENTION

The present invention relates to Internet technologies generally and particularly to web services and the Universal Description, Discovery, and Integration (UDDI) specification.

### BACKGROUND OF THE INVENTION

The Internet has become one of the leading backbones for transferring information throughout society. Businesses and individuals are frequently challenged by the inefficient methods that are available to them for disseminating information on the Internet. Businesses would like to be able to effectively distribute relevant information about their products and services to customers as well as other businesses. Individuals could also benefit from information that would show goods and services available to them specifically in a given environment. It has become useful for businesses and individuals to share their information and services automatically without the need for human interaction via a browser or other similar interface. Web services provide a solution to this need by standardizing a way of integrating Web-based applications over an Internet protocol backbone. Web Services standards and protocols include, but are not limited to, XML (extensible markup language), SOAP (simple object access protocol), WSDL (web service definition language), and UDDI. Web services share business logic, data, and processes through a programmatic interface across a network. Web services based applications are designed to facilitate direct device-to-device communications

Web services allow different applications from different sources to communicate with each other without time-consuming custom coding and without being tied to any one operating system or programming language. The well-known UDDI specification establishes a platform-independent, open framework for the discovery and invocation of web services. UDDI is a comprehensive, open industry initiative enabling businesses and individuals to discover each other and define how they interact and share information over the Internet. UDDI is not application specific so any application that is compatible with the UDDI specification would be able to communicate with (i.e. find and invoke) any other compatible application or service through the use of web services.

Although the UDDI specification is evolving, this invention will remain pertinent because it applies to the fundamental operations required of UDDI. Fundamentally, UDDI specifies a web services directory (or registry) service that permits publish and query operations to the directory. This means users or other programs can describe and advertise their own services by publishing them in a directory as well as locate other web services offered by other entities. Indeed, UDDI offers web services analogies for the white, yellow, and green pages of a phone directory. UDDI directories are often hosted on servers on networks, both private (e.g. inside a corporate enterprise) or public (e.g. globally accessible on the Internet). The UDDI community has traditionally focused on the business environment; that is, public and private deployments of highly available, robustly provided web services. With UDDI v3, much attention has been paid to the interoperation of sets of UDDI registries, which are comprised of many individual records describing available services. Thus, UDDI affords that two UDDI directories may exchange change records (describing changes to web services or metadata listed in their directories) to update one another with the latest information. For example, a given UDDI directory may have received web service additions or changes that are published by a particular business, which wants those services globally advertised. That directory would transmit the additions through a change record mechanism to other UDDI directories it knows about. In this manner, UDDI directories can keep each other up to date. Usually these inter-UDDI directory communications are made on demand or periodically, but usually not continuously. That is, change records are aggregated together in sequential order (often determined by chronological ordering) and sent in batches.

UDDI registries can be located on almost any device that connects to a network. Furthermore, as web services become more prolific, devices that take advantage of them will be inundated with change records to add, delete, and modify each individual web service. Thus, there is a need to optimize the batching, transmission, and processing of such change record sequences.

### BRIEF DESCRIPTION OF THE DRAWINGS

The present invention is illustrated by way of example and is not limited by the figures of the accompanying drawings, in which like references indicate similar elements, and in which:

FIG. 1 demonstrates an embodiment of a UDDI Change Record Optimizer in one networked configuration.

FIG. 2 illustrates the architecture of a device with the UDDI Change Record Optimizer resident on it.

FIG. 3 demonstrates one embodiment of the functionality of UDDI Change Record Optimizer.

FIG. 4 illustrates a common add/modify/delete set of change records.

FIG. 5 illustrates a flow chart of a process that one embodiment of a UDDI Change Record Optimizer follows to remove unnecessary sets of add/modify/delete change records.

FIG. 6 illustrates a flow chart of a process that one embodiment of a UDDI Change Record Optimizer follows to remove unnecessary sets of add/modify/delete change records in reverse sequential order

FIG. 7 illustrates a common update/update set of change records.

FIG. 8 illustrates a flow chart of one process that one embodiment of a UDDI Change Record Optimizer follows to remove unnecessary sets of update/update change records.

FIG. 9 illustrates a flow chart of one process that one embodiment of a UDDI Change Record Optimizer follows to filter unnecessary non-wireless change records on wireless devices.

FIG. 10 illustrates a flow chart of one process that one embodiment of a UDDI Change Record Optimizer follows to filter change records not relevant to a current physical location.

FIG. 11 illustrates a flow chart of one process that one embodiment of a UDDI Change Record Optimizer follows to filter change records through a firewall.

FIG. 12 illustrates a process that one embodiment of a UDDI Change Record Optimizer can use to divide the set of unprocessed change records into more manageable subsets.

FIG. 13 illustrates a process that one embodiment of a UDDI Change Record Optimizer can use to sort the set of unprocessed change records according to web service unique key identifier.

### DETAILED DESCRIPTION

A method for optimizing the processing of UDDI change records is described. In some instances, well-known elements and theories, such as the Internet, client-server architecture, LANs, WANs, firewalls, etc. have not been discussed in special details in order to avoid obscuring the present invention.

The term “web service type” used herein refers to any unique key or identifier that specifies a particular (specific individual) web service. Often this key is a globally unique identifier or GUID. This term does not refer to a set of two or more web services sharing a common function.

In the UDDI specification, the typical use of change records exchanges and operations fall under the UDDI Inter-Node operation and the replication API. However, the present invention can also be applied to other similar change record exchanges that may fall outside of this particular usage API. Each change record contains a unique key that identifies a particular web service to be updated. Each change record also contains an updated sequence order number (USN) that is guaranteed to be monotonically increasing in value. In the description of the present invention, change records with a given key are ordered by their USN. This ordering is usually a chronological ordering based on when updates were published to the originating UDDI directory.

Unless stated otherwise (e.g. such as for filtering operations), all embodiments of the present invention require and ensure that following any optimizations, the application of the resulting minimized list of change records will result in exactly the same updated results in a target UDDI directory as application of the original change record list. This includes cases where USN sequential order may not strictly be preserved within a given web service type (i.e. an identical key) as well as across web service types. If change record list filtering is employed, the above restriction applies in that all embodiments of our invention require and ensure that following our optimizations, the application of the resulting minimized list of change records with certain records filtered out will result in exactly the same updated results in a target UDDI directory as application of the filtered original change record list (e.g. the original change record list that has been filtered using the same parameters.) For clarity of invention and by way of illustration, our descriptions will generally be limited to processing change order lists that preserve the USN sequence for a given key (unique web service.)

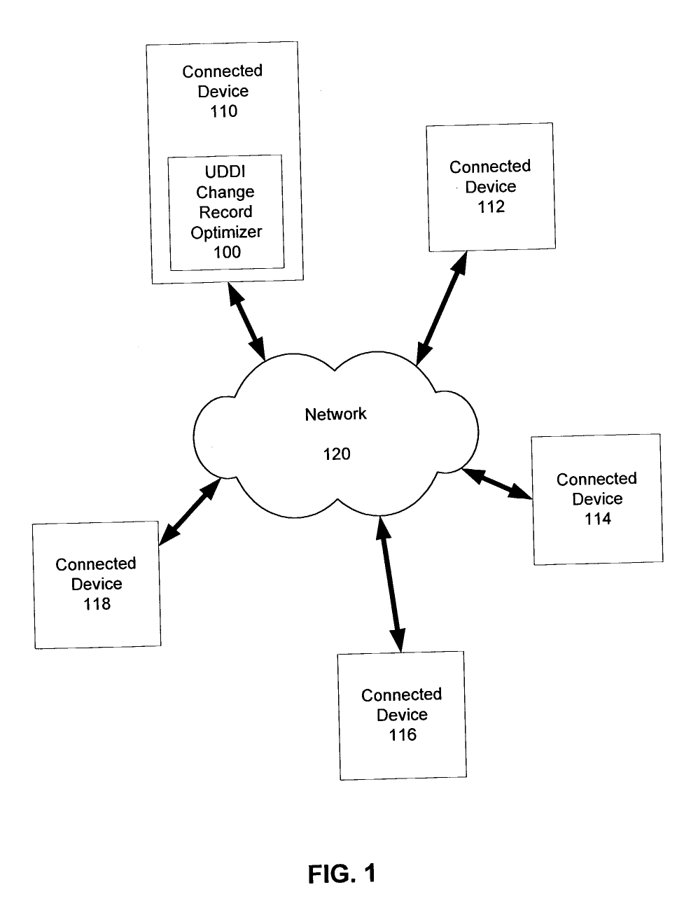

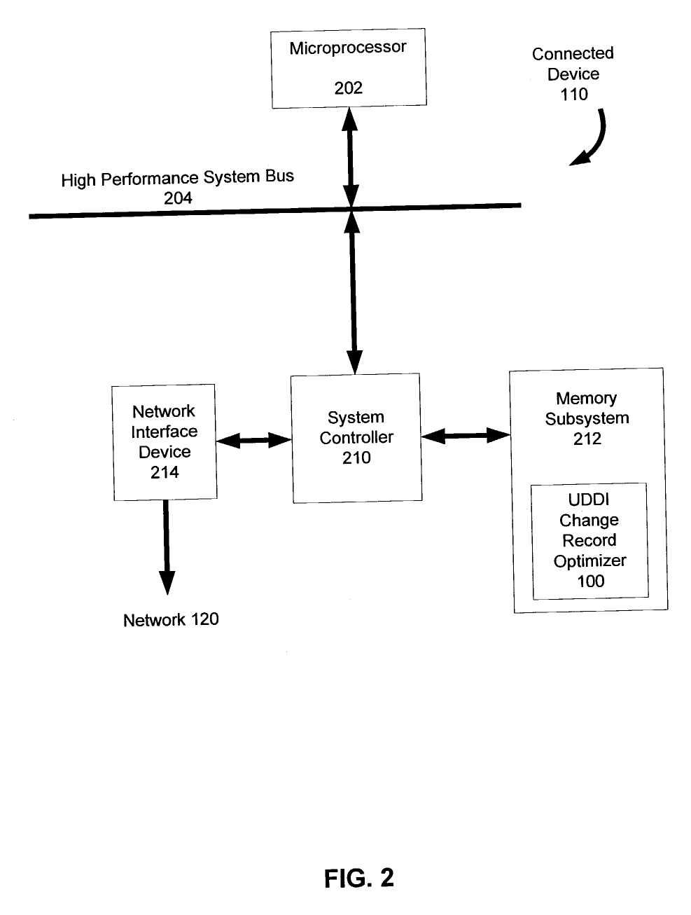

FIG. 1 illustrates an embodiment of a UDDI Change Record Optimizer 100 in one networked configuration. In this embodiment, the UDDI Change Record Optimizer 100 resides on Connected Device 110 but potentially could reside on any one Connected Device or a combination of multiple Connected Devices including 110, 112, 114, 116, and 118. In one embodiment there are multiple UDDI directories per Connected Device. In another embodiment, every device connected to the Internet would have its own UDDI server application running on it. Some examples of Connected Device 110 are, but not limited to, add-in circuit boards, standalone electronic apparatuses, virtual machines, wireless handheld devices, and general-purpose computer systems. The architecture within Connected Device 110 is illustrated in FIG. 2. All devices are interconnected through Network 120. Some examples of Network 120 are, but not limited to, ad hoc networks, mobile networks, virtual (private) networks, overlay networks, LANs (local-area networks), WANs (wide-area networks), intranets, and internets such as the Internet. Also, the connections to Network 120 can be via, but not limited to, copper wire, lasers, microwaves, communication satellites, RF transmissions, etc.

FIG. 2 illustrates one architecture of Connected Device 110 with the UDDI Change Record Optimizer 100 resident on it. The Connected Device 110 architecture comprises Microprocessor 202 coupled to High Performance System Bus 204. System Controller 210 is also coupled to High Performance System Bus 204. Additionally, System Controller 210 is coupled to Memory Subsystem 212 and to Network Interface Device 214. Memory Subsystem has UDDI Change Record Optimizer 100 located on it. Network Interface Device is connected to Network 120. These elements perform their conventional functions well known in the art. Additionally, it should be apparent that the UDDI Change Record Optimizer could consist of any of a number of different embodiments such as a software program stored in Memory Subsystem 212, as hardware logic stored in the Memory Subsystem 212, as an embedded program that runs in the Memory Subsystem 212, etc.

UDDI utilizes servers of all types and sizes to broadcast change events for relevant web services across Network 120, which allows the UDDI framework to propagate across any number of devices on Network 120. It should be apparent to one ordinarily skilled in the art that Connected Device 110 could be a variety of different devices such as desktop PCs, servers, handhelds, or virtual machines. Each Connected Device could have zero or more UDDI directories and/or the UDDI Change Record Optimizer 100 located on it. Each Connected Device that has a UDDI server located on it would broadcast updates to any web services relevant to it. Moreover, it should be apparent to one ordinarily skilled in the art that Connected Device 110 may have more components than what is shown.

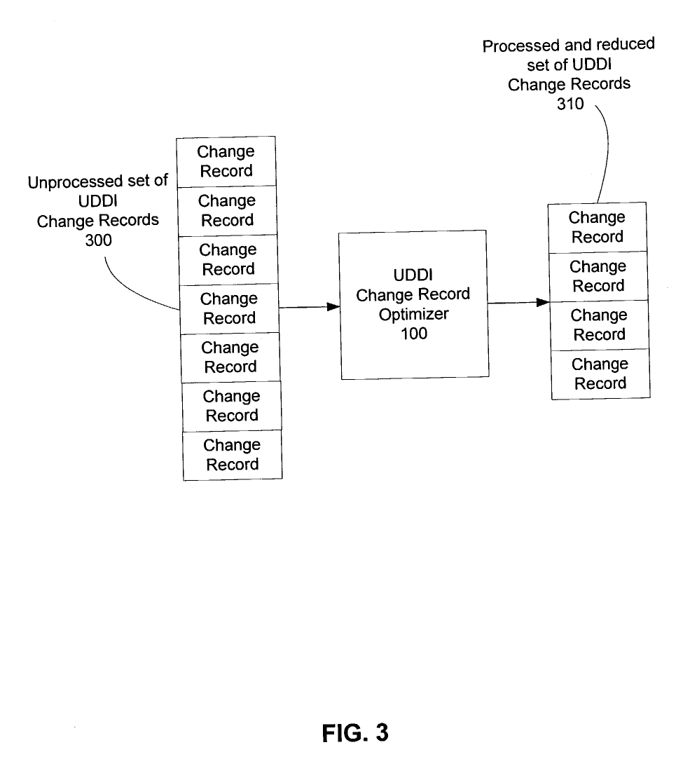

FIG. 3 demonstrates one embodiment of the functionality of UDDI Change Record Optimizer 100. The UDDI Change Record Optimizer 100 receives, as input, a number of UDDI Change Records 300 and minimizes the number of change records to the amount needed. Once the processing is complete the UDDI Change Record Optimizer 100 dispatches, as output, the Processed UDDI Change Records 310 constituting the minimum number of change records required (potentially a closer to optimal number). The number of Processed UDDI Change Records 310 that are output from the UDDI Change Record Optimizer 100 will always be less than or equal to the number of Unprocessed UDDI Change Records 300 that are input into it.

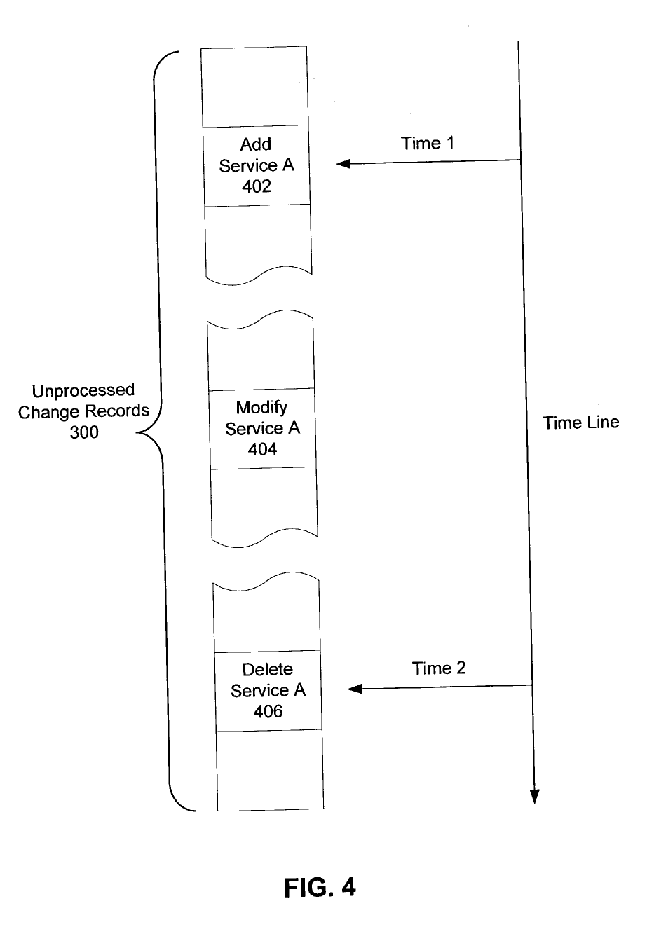

A number of procedures exist that help reduce the amount of change records processed for a given device. FIG. 4 illustrates a common add/modify/delete set of change records. A set of Unprocessed UDDI Change Records 300 is shown. When processed, the set of change records is operated on one at a time in a first-received-first-processed manner. Within this specific example set there exists an Add Service A change record 402 (where A denotes the web service type or key/identifier) that was received at Time 1 and a Delete Service A change record 406 that was received at Time 2. Given this scenario, it is not necessary to process either change record because ultimately Service A is deleted. Additionally, any modification to Service A between Add Service A change record 402 and Delete Service A change record 406, such as Modify Service A change record 404, is irrelevant and should be discarded along with the aforementioned Add and Delete change records. Essentially, it is more efficient to spot an instance of this combination and discard all applicable change records than to process them.

Another gain in efficiency arises from not having to consume network bandwidth (or network transmission costs per bit) to send redundant or unnecessary information. This is particularly important when the number of redundancies is high or in cases where transmissions consume other valuable resources such as battery power. Such scenarios can arise frequently in mobile computing environments, where there are high rates of change and computational processing is often cheaper than network communication.

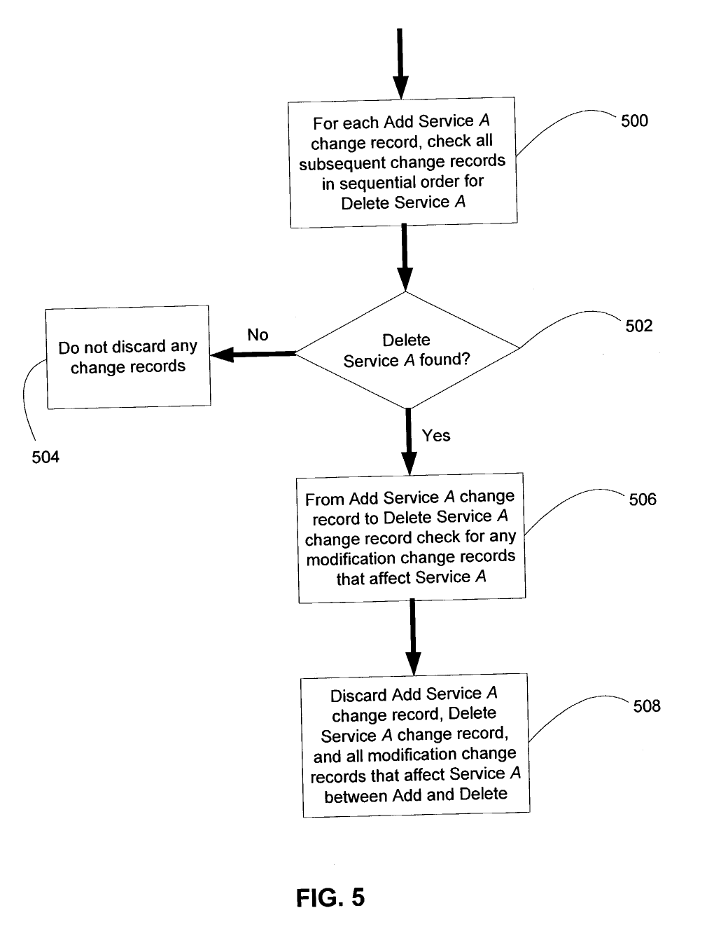

FIG. 5 illustrates a step-by-step process of one embodiment utilized to remove sets of add/modify/delete change records from the set of Unprocessed Change Records 300. In block 500 an Add Service A change record is identified from the set of Unprocessed Change Records 300 and a linear search begins through the set of Unprocessed Change Records 300 in sequential order. Block 502 queries if a subsequent Delete Service A change record has been found. If not, block 504 dictates that no change records will be discarded. If a subsequent Delete Service A change record has been found then a linear search begins again in block 506 through the set of Unprocessed Change Records 300 to find all modification change records associated with Service A and flags them. Block 508 then discards the Add Service A change record, the Delete Service A change record, and all modification change records that affect Service A between the them.

In another embodiment, the list of Unprocessed Change Records 300 in FIG. 4 is scanned backwards (i.e. reverse USN order) from the end of the list towards the start of the list. If a Delete Service A 406 change record is found, then all change records, including the Delete Service A change record, for web service type/key A are removed from that point to the start of the list. This can be done because the Delete Service A operation removes the need for all preceding web service type/key A operations in the list, regardless of operation type.

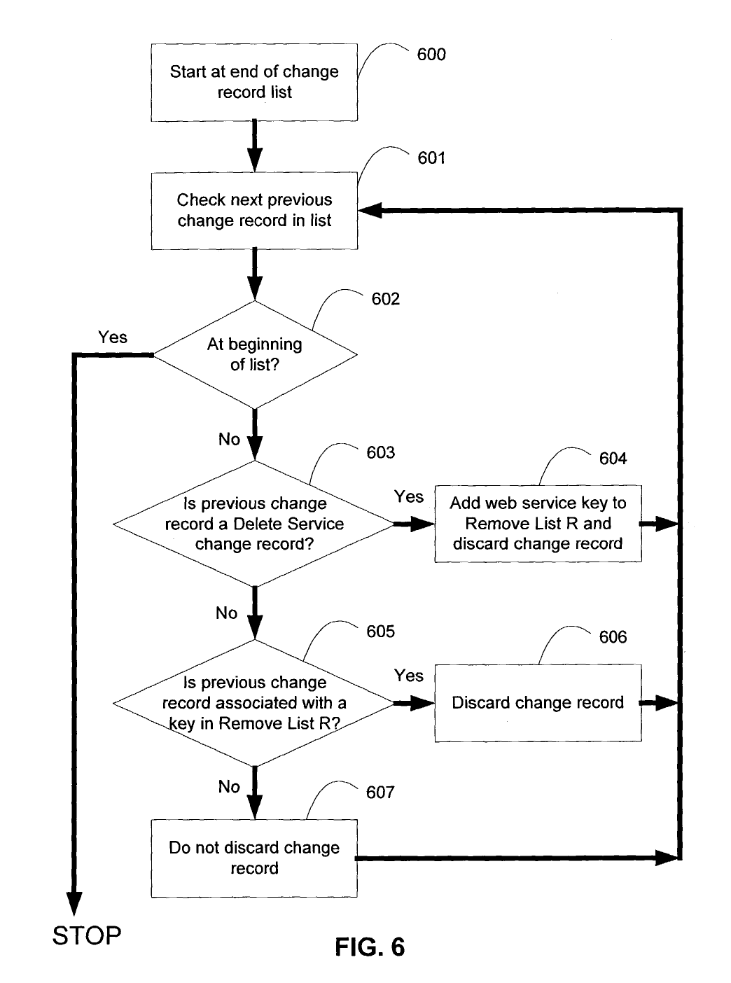

FIG. 6 illustrates one embodiment of a method that involves checking for unnecessary change records in reverse sequential order and discarding them. The scan for unnecessary change records starts at the end of the change record list in Box 600. The scan proceeds one change record at a time in reverse sequential order by checking each previous change record in the list (Box 601). If the scan reaches the beginning of the list of change records it stops, this is checked (602). The scan always is checking for Delete Service change records (603). Once the scan finds a Delete Service A change record (where A denotes the web service type or key/identifier) the key A is added to a Remove List R and the Delete Service A change record is discarded (604). As the scan proceeds from the end of the list to the beginning of the list a check is made to see if the current change record's web service type/key is in Remove List R (605). If it is, the record is removed (606). If none of these apply, the item is left unchanged or subjugated to other, possibly parallel, optimization procedures (607). In another embodiment, multiple optimization procedures may operate at a given time.

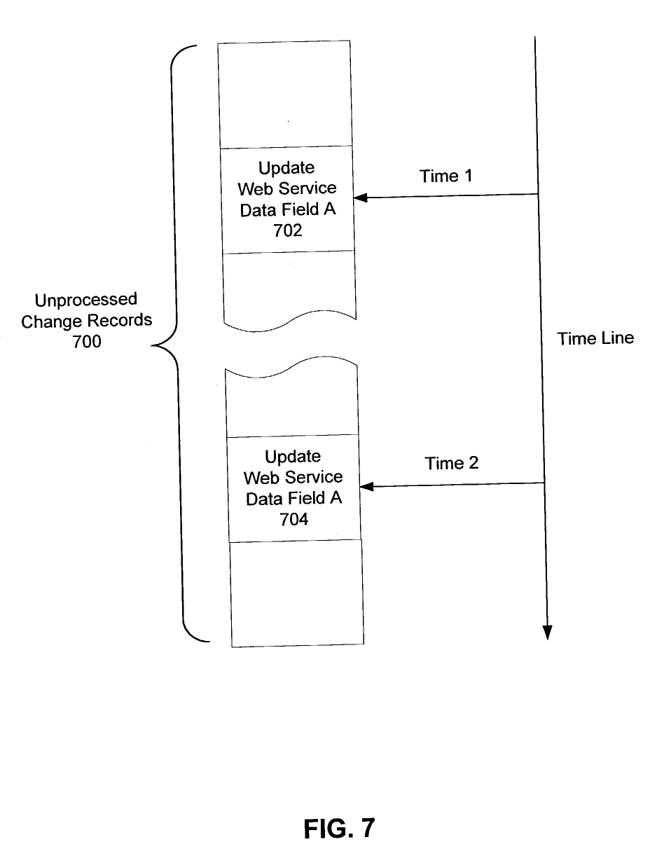

Another common set of change records that exhibits redundancy is illustrated in FIG. 7. A set of Unprocessed UDDI Change Records 700 is shown. When processed, the set of change records is operated on one at a time in a first-received-first-processed manner. In this specific scenario there is an Update Web Service Data Field 702 change record received at Time 1 and an Update Web Service Data Field 704 change record received at Time 2. These two update change records are targeting the same data field (i.e. datum) and therefore, unless the changes are to different bits of the data field, only the second Update Web Service Data Field change record at Time 2 is valid. The prior change record at Time 1 contains irrelevant data that will be overwritten. Thus, in a scenario where more than one update change record targets the same data field only the most recent request is valid; all previous change records that update the data field can be discarded.

Change records may not be contiguous in the list of change records being processed. In one embodiment, update change records targeting the same data field may have a cumulative effect. For instance, bit masking operations might selectively change one bit within a given data field without having an effect on other bits within the same data field. If this is the case, then all of these incremental update (change record) operations for that given data field item can be accumulated into a final result by utilizing bit masks, subfields, etc. The change records for these incremental updates are removed and the final resultant change record, which has the same effect as all of the combined incremental updates, can be inserted at the position of the last incremental update.

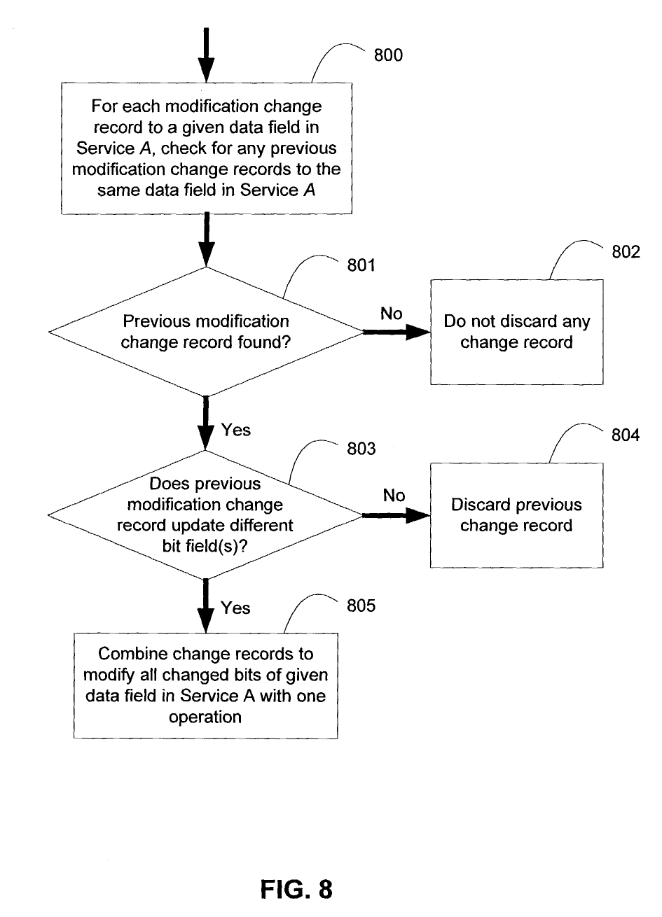

FIG. 8 illustrates the step-by-step process utilized to remove redundant change records that update a given data field, described in FIG. 7, from the set of Unprocessed Change Records 700. In block 800 a change record that updates a specific data field is identified from a set of unprocessed change records and a search begins in reverse sequential order starting from the time of the most up-to-date change record. Block 801 queries if a previous change record that updates the same data field has been found. If a previous change record that updates the same data field is not found no change records will be discarded (block 802). If one or more previous change records that update the same data field have been found then block 803 queries whether or not the previous change record updates the same bits in the data field. If the same bits are being updated then the previous change record can be discarded (block 804). Otherwise, the multiple change records can be accumulated into a final result for a data field update in block 805.

In addition to recognizing instances of specific combinations of change records illustrated in FIG. 4 and FIG. 7, the UDDI Change Record Optimizer can also utilize any environmental data that is applicable to minimize the number of change records to be exchanged between UDDI servers. Often these result in culling or filtering a given web service type or a set of web service types from the list. In one embodiment, all devices charged with processing change records possess filtering information such as metadata, permissions, access control lists, policies, databases, etc (possibly gathered from other connected devices), from which change record culling or filtering may be driven.

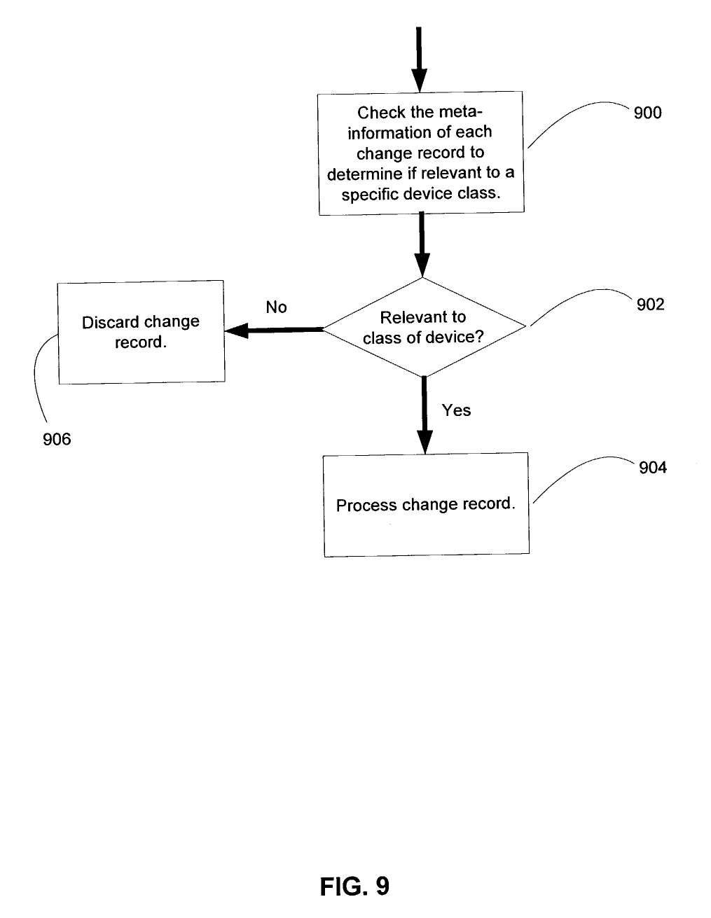

In one embodiment, one specific class of devices comprise a segment of the devices connected to a given network and UDDI servers are located on all devices present on that network. In this environment, change records exchanged between all devices on the network can have meta-information associated with them to distinguish the device classes. Certain change records would be only be valid on a certain set of devices that does not include the specific class in question. For example, the class of devices excluded could be wireless devices because certain web services require compute power beyond that of which a reasonable wireless device would possess. The UDDI Change Record Optimizer would include a filter incorporated into it that checks each change record to determine whether it is relevant for a specific device class. FIG. 9 illustrates a step-by-step process of one embodiment where change records not relevant to a specific class of devices will be filtered out and not passed to those devices. Block 900 checks the meta-information associated with each change record, which reveals if the change record is relevant to the specific class of devices. Block 902 queries if the change record is relevant to the particular device class. If the change record is relevant, the devices associated with that class will process it in block 904. If the change record is not relevant then the UDDI Change Record Optimizer device would discard the change record in block 906.

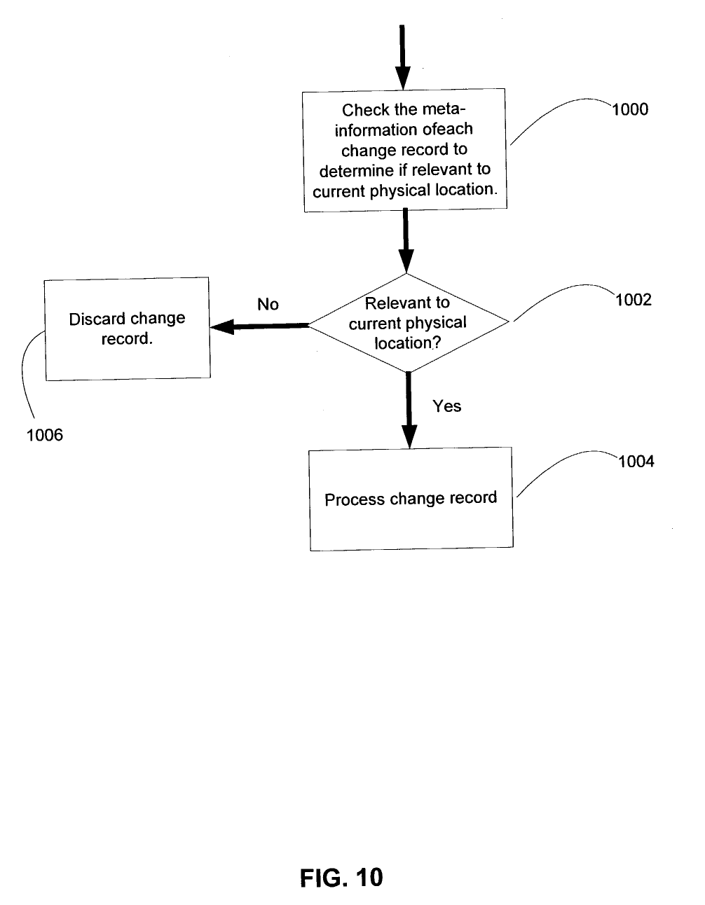

Current physical location can also be a relevant factor in determining whether to process a change record. In another embodiment of the invention, wireless devices comprise a segment of the devices connected to a given network and UDDI servers are located on all devices present on that network. In this environment as the wireless devices move around between different physical locations different services become available to them within the proximate vicinity. For example, a non-wireless printer could be located in a fixed position and have a web service associated with it. When wireless devices connected to the same network get within the proximate vicinity of the printer, determined using whatever means available, the change records associated with that printer could become relevant to those wireless devices. FIG. 10 illustrates a step-by-step process of one embodiment where change records associated with devices at the current physical location will be processed and change records associated with devices that are not at the current physical location will be filtered out by the UDDI Change Record Optimizer. Block 1000 checks the meta-information associated with each change record, which reveals if the change record is relevant to the current physical location. Block 1002 queries if the change record is relevant to the current physical location. If the change record is relevant, the wireless device will process it in block 1004. If the change record is not relevant then the wireless device discards the change record in block 1006.

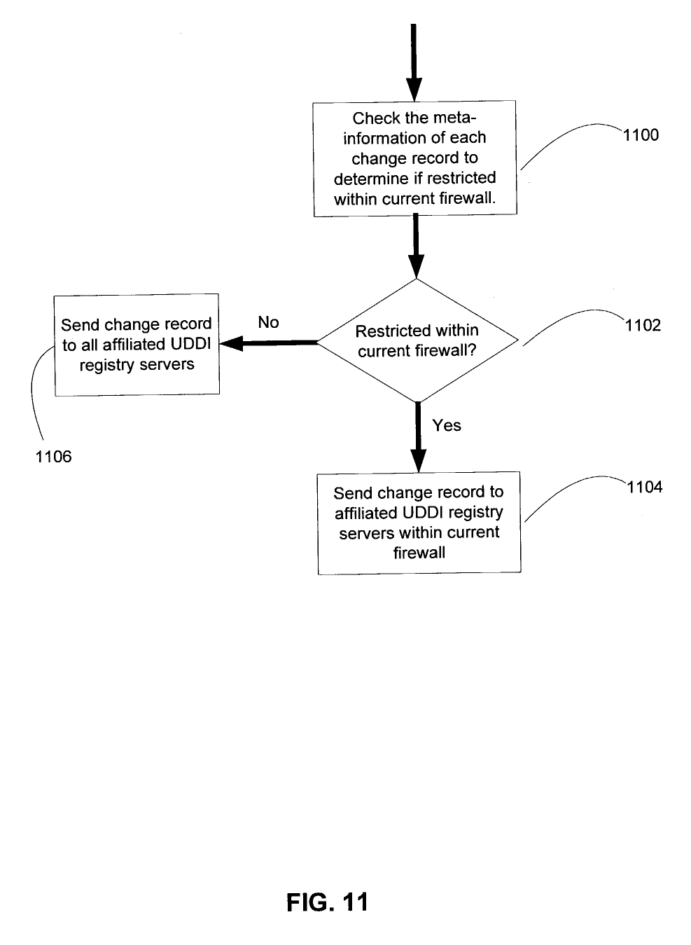

Restricting the exchange of specific change records between UDDI servers because of a firewall is also a functional use of the UDDI Change Record Optimizer. Web services can be confidential in nature, for example, when associated with different functions within a corporation's intranet so there exists the need for certain web services to be only processed on and sent to devices that are behind a firewall. Change records can include meta-information that conveys access rights. In embodiment the UDDI Change Record Optimizer can be located on a corporate server and utilized similarly to a firewall by filtering change records. Change records that are not restricted can be propagated freely inside and outside of the corporation's firewall, whereas change records that are restricted are not allowed to pass through the UDDI Change Record Optimizer's portal to the Internet. FIG. 11 illustrates a step-by-step process of one embodiment where change records firewall restrictions are determined and then subsequently exchanged with the proper UDDI servers. Block 1100 checks the meta-information associated with each change record, which reveals if the change record is restricted within a firewall or not restricted. Block 1102 queries if the change record is restricted. If the change record is not restricted the UDDI Change Record Optimizer propagates the change record to all relevant UDDI servers in block 1104. If the change record is restricted then UDDI Change Record Optimizer exchanges the change record only with UDDI servers within the firewall in block 1106.

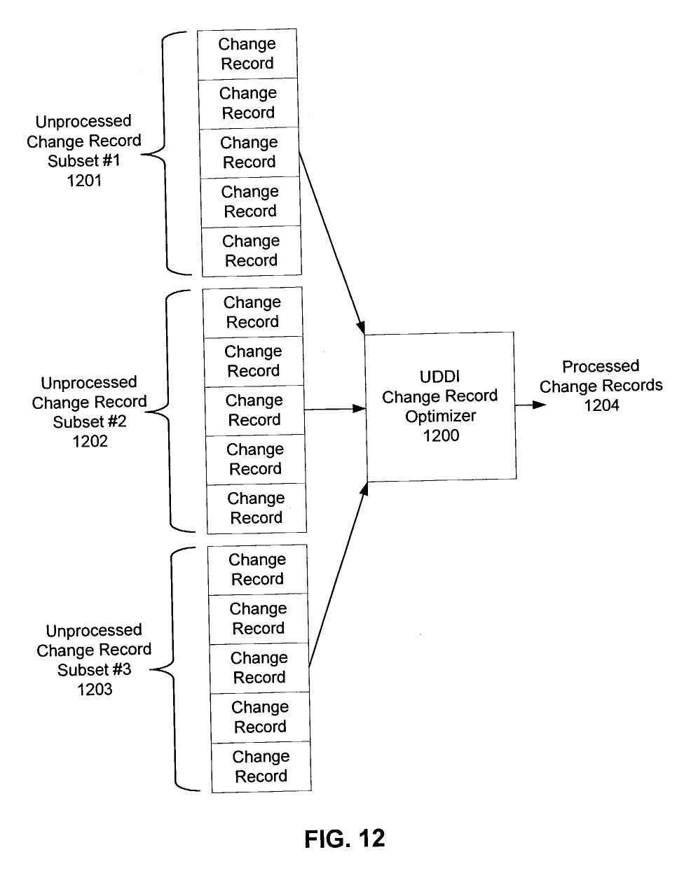

Many devices that could potentially have the UDDI Change Record Optimizer located on them have limited amounts of storage space and memory. If the number of change records that need to be processed exceeds the capacity of the device with a one pass algorithm it could be necessary to break up the change records into manageable chunks to process individually and make multiple passes to complete the entire optimization process. FIG. 12 illustrates one embodiment of this possibility where the UDDI Change Record Optimizer 1200 has a limited amount of resources to process the change records. In this embodiment the unprocessed change records are further broken down into Unprocessed Change Record Subset #1 1201, Unprocessed Change Record Subset #2 1202, Unprocessed Change Record Subset #3 1203. The UDDI Change Record Optimizer 1200 is given each subset separately as input, processes them one at a time, and outputs the Processed Change Records 1204. It should be apparent to one ordinarily skilled in the art that an individual UDDI Change Record Optimizer 1200 could accomplish the processing of each subset serially, the processing could be done on one device in parallel on different threads, or it could be done on multiple devices each with their own UDDI Change Record Optimizer 1200.

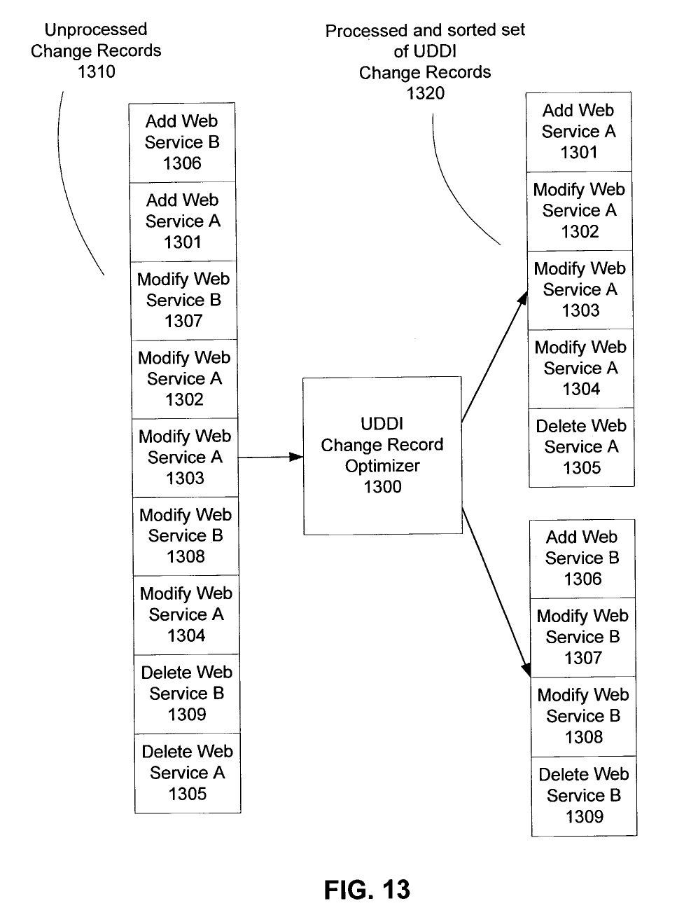

In this scenario it would be beneficial to optimize the set of UDDI change records by utilizing the UDDI Change Record Optimizer to sort the set of unprocessed UDDI Change Records according to web service type. FIG. 13 illustrates one embodiment of a sorting result using this optimization method. The UDDI Change Record Optimizer 1300 inputs a set of Unprocessed Change Records 1310 and sorts them into a set of Processed and Sorted Change Records 1320. All change records associated with a given web service key are situated together and in sequential USN order (i.e. chronological order) prior to further processing. The remainder of other optimization techniques performed by the UDDI Change Record Optimizer 1300 can then be completed more efficiently.

In one embodiment, sorting can be done in linear time—O(N), where N is the number of change records—by scanning the original list. For each new web service type not seen before (i.e. unique web service identified by a key), a new list (first-in-first-out (FIFO) queue) is created and the change record is inserted. For each web service type seen before, the corresponding list is found and the item is appended. Since the original list was in chronological order (i.e. USN sequential order), the resulting queues are in USN order as well. In one embodiment the lists can be merged back together into a single list. In another embodiment, the lists or processed separately, either sequentially or in parallel or in some combination thereof.

Thus, a method for optimizing the processing of UDDI change records has been disclosed. Although the UDDI Change Record Optimizer has been described particularly with reference to the figures, it may appear in any number of systems. The UDDI Change Record Optimizer can be co-located with the UDDI server either by being incorporated into the UDDI server itself or implemented as a process on the same machine. The Optimizer can also reside on a separate machine such as being implemented as a service on a well-connected server. It can accept change record sets from the server, or it can intercept them like a proxy as they are sent to affiliated UDDI servers. It is further contemplated that many changes and modifications may be made by one of ordinary skill in the art without departing from the spirit and scope of the disclosed UDDI Change Record Optimizer.

What is claimed is:

1. A method for optimizing the processing of UDDI change records, comprising:
receiving a list of change records; and
minimizing the list of change records that need to be processed.

2. The method according to claim 1, wherein the receiving of the change records is accomplished in an on-demand manner.

3. The method according to claim 1, wherein the receiving of the change records is accomplished in a periodic, automatic manner.

4. The method according to claim 1, wherein the processing of change records further comprises:
recognizing instances of sequentially ordered combinations of change records consisting of:
add web service;
perform zero or more operations on web service; and
delete web service.

5. The method according to claim 4, further comprising:
removing said instances of sequentially ordered combinations of change records after they are recognized.

6. The method according to claim 4, wherein the individual change records comprising the sequentially ordered combinations are interleaved with other arbitrary change records.

7. The method according to claim 1, wherein the processing of change records further comprises:
recognizing instances of sequentially ordered combinations of change records consisting of:
update web service with change to a data field;
update web service with change to the same data field;
said instances are recognized when consisting of two or more updates.

8. The method according to claim 7, further comprising:
removing all change records updating the data field with the exception of the final change record in sequential order.

9. The method according to claim 7, further comprising:
accumulating all specific changes associated with the data field; and
creating a change record that applies all accumulated bit changes to the data field.

10. The method according to claim 1, wherein the processing of change records further comprises:
implementing change record filters designed to limit the type of change records sent to another UDDI registry.

11. The method according to claim 10, wherein the implementation of the filters further comprises:
recognizing and removing all irrelevant change records.

12. The method according to claim 10, wherein the implementation of the filters further comprises:
limiting the class of device that particular change records are sent to.

13. The method according to claim 10, wherein the implementation of the filters further comprises:
recognizing and removing all change records that are valid to a given device only in a given physical location when the device is not in the physical location.

14. The method according to claim 10, wherein the implementation of the filters further comprises:
limiting the propagation of change records across a network to exclude those only useful within a firewall or secure network domain.

15. A machine readable medium having embodied thereon instructions, which when executed by a machine, causes the machine to optimize the processing of UDDI change records, comprising:
receiving a list of change records; and
minimizing the list of change records that need to be processed.

16. The method according to claim 15, wherein the processing of change records further comprises:
recognizing instances of sequentially ordered combinations of change records consisting of:
add web service;
perform zero or more operations on web service; and
delete web service.

17. The method according to claim 16, further comprising:
removing said instances of sequentially ordered combinations of change records after they are recognized.

18. The method according to claim 16, wherein the individual change records comprising the sequentially ordered combinations are interleaved with other arbitrary change records.

19. The method according to claim 15, wherein the processing of change records further comprises:
recognizing instances of sequentially ordered combinations of change records consisting of:
update web service with change to a data field;
update web service with change to the same data field;
said instances are recognized when consisting of two or more updates.

20. The method according to claim 19, further comprising:
removing all said change records updating said data field with the exception of the final change record in sequential order.

21. The method according to claim 19, further comprising:
accumulating all specific changes associated with the data field; and
creating a change record that applies all accumulated bit changes to the data field.

22. The method according to claim 15, wherein the processing of change records further comprises:
implementing change record filters designed to limit the type of change records sent to another UDDI registry.

23. The method according to claim 22, wherein the implementation of the filters further comprises:
limiting the class of device that particular change records are sent to.

24. The method according to claim 22, wherein the implementation of the filters further comprises:
recognizing and removing all change records that are valid to a given device only in a given physical location when the device is not in the physical location.

25. The method according to claim 22, wherein the implementation of the filters further comprises:
limiting the propagation of change records across a network to remain within a firewall.

26. A system having a processor and bus, comprising:
memory coupled to said processor, said memory adapted to load the UDDI change record optimizer; and
a network access device coupled to said bus, said network access device adapted to receive and transmit change records across said network.

27. The system according to claim 26, further comprising:
an implementation of a UDDI server on said system.

28. The system according to claim 27, further comprising:
the UDDI change record optimizer integrated into the UDDI server.

29. The system according to claim 26, further comprising:
a mobile, hand-held device that has wireless network access.

30. The system according to claim 26, further comprising:
a server that processes change records for one or more clients.
